(19) United States
(12) Patent Application Publication
(10) Pub. No.: US 2026/0203187 A1
(43) Pub. Date: Jul. 16, 2026

(54) MONITORING STATION HEALTH IN DATA INTEGRATION FRAMEWORKS

(71) Applicant: Honeywell International Inc., Charlotte, NC (US)

(72) Inventors: Blake Puhak, Richmond, VA (US); Emily Weisensale, Richmond, VA (US); Daniel Giorgis, Glen Allen, VA (US); Owen Michael James, Sandy Hook, VA (US); Stephen Holicky, Richmond, VA (US)

(21) Appl. No.: 19/015,648

(22) Filed: Jan. 10, 2025

(51) Int. Cl. G06F 11/3604; G06F 9/54; G06F 11/3698

(52) U.S. Cl. CPC G06F 11/3612; G06F 9/54; G06F 11/3698

(57) ABSTRACT

Techniques for monitoring station health data in a data integration framework are disclosed. An Application Programming interface (API) implementable by each of a plurality of applications within the data integration framework, which has a plurality of stations, is provided. One or more application-specific metrics of each of the plurality of applications are detected. A health parameter corresponding to each of the one or more application-specific metrics is computed based on the detected one or more application-specific metrics. Information corresponding to the one or more application-specific metrics and the computed health parameters for each of the plurality of applications are retrieved, aggregated, and processed to assess health each of the plurality of stations. The assessed health of each of the plurality of stations and at least one interactive element corresponding to the one or more application-specific metrics to manage and optimize performance are displayed using a Graphical User Interface (GUI).

### BACKGROUND

Generally, organizations employ various devices, Internet-of-Things (IoT)-based sensors, controllers, IoT-based electrical appliances, IoT-based cameras, and the like, on their premises (i.e., at a facility, such as a warehouse of the organization) for various purposes. For instance, an industrial plant may include one or more controllers to control various processes related to manufacturing a product. Similarly, a manufacturing unit may employ various IoT-based sensors to determine different parameters related to an operating environment of a product that is to be manufactured. Likewise, an automation industry may utilize IoT-based sensors for fleet management, monitoring automobile performance metrics, and controlling various IoT-based devices.

Conventionally, the organizations that employ various devices interconnect these devices through software platforms. The interconnection of these devices is done to manage the operations of the devices, monitoring performance of the devices, and the like. The interconnection through software platforms also enables provision of unified interfaces and functionality for users. Examples of such software platforms may include data integration frameworks, such as Niagara platform and the like.

### SUMMARY

In the present subject matter, a system for monitoring station health in a data integration framework may include a processing unit. The data integration framework may be, for example, Niagara platform. The processing unit may provide an Application Programming interface (API) implementable by each of a plurality of applications within the data integration framework. The data integration framework may include a plurality of stations. Each station may correspond to one or more computing devices operating within the data integration framework. Each of the plurality of applications may correspond to a station of the plurality of stations. The processing unit may detect, via the API, one or more application-specific metrics of each of the plurality of applications. The one or more application-specific metrics may be indicative of performance and/or configuration of the application. The one or more application-specific metrics are dynamically determinable by each application. The processing unit may compute, via the API, a health parameter corresponding to each of the one or more application-specific metrics based on the detected one or more application-specific metrics. In an example, the processing unit may compute, via the API, the health parameter corresponding to each of the one or more application-specific metrics based on a comparison with a threshold corresponding to each of the one or more application-specific metrics. The health parameter may be indicative of health level of the corresponding application. The processing unit may retrieve, via the API, information corresponding to the one or more application-specific metrics and the computed health parameters for each of the plurality of applications. Further, the processing unit may aggregate the retrieved information corresponding to each of the plurality of applications. Then, the processing unit may process the retrieved information to assess health each of the plurality of stations. The processing unit may display, using a Graphical User Interface (GUI), the assessed health of each of the plurality of stations and at least one interactive element corresponding to the one or more application-specific metrics to manage and optimize performance. The GUI may be, for example, station health dashboard.

In an example, the at least one interactive element may include a configuration link associated with each of the one or more application-specific metrics of each of the plurality of applications. The processing unit may receive, via the API, the configuration link. The configuration link may facilitate modification of settings corresponding to the application-specific metric of the application. Further, the processing unit may display, using the GUI, the assessed health of each of the plurality of stations, and the received configuration links corresponding to each of the one or more application-specific metrics of each of the plurality of the applications. The processing unit may display the assessed health of each of the plurality of stations via a categorical assessment. The categorical assessment may be indicative of the performance and/or configuration of each of the plurality of applications as one of: optimal and non-optimal.

The processing unit may receive inputs corresponding to selection of the at least one element for each of the plurality of applications. The processing unit may provide, using the GUI, access to detailed health information corresponding to each of the plurality of applications in response to the selection of the at least one element. In an example, the processing unit may display, using the GUI, the assessed health of each of the one or more application-specific metrics as at least one of: a numeric score and a colour-coding.

In an example, the present subject matter may enable monitoring health of newly-installed applications. In this regard, the processing unit may detect installation of a new application to the data integration framework and may provide the API to the new application. The provision of the API may allow plugging of the application for monitoring station health. The processing unit may detect, via the API, one or more application-specific metrics of the new application. The one or more application-specific metrics of the new application may be indicative of performance and/or configuration of the new application.

The processing unit may allow, via the API, each of the plurality of applications to define the one or more application-specific metrics and a description corresponding to each of the one or more application-specific metrics. Further, the processing unit may detect, via the API, the one or more application-specific metrics corresponding to each of the plurality of applications based on the defining of the one or more application-specific metrics by each of the plurality of applications. The processing unit may query, using a station health service, the data integration framework for the plurality of applications that has implemented the API. The processing unit may detect, via the API, the one or more application-specific metrics of each of the plurality of applications based on the querying.

In an example, a method for monitoring station health in a data integration framework. The data integration framework may be, for example, Niagara platform. The method may include implementing, by each of a plurality of applications within the data integration framework, an API. The data integration framework may include a plurality of stations. Each station may correspond to one or more computing devices operating within the data integration framework. Each of the plurality of applications may correspond to a station of the plurality of stations. The data integration framework may be queried by a station health service for the plurality of applications that has implemented the API. One or more application-specific metrics of each of the plurality of applications may be detected based on the querying. The one or more application-specific metrics may be indicative of performance and/or configuration of the application. The one or more application-specific metrics may be dynamically determinable by each application. A health parameter corresponding to each of the one or more application-specific metrics may be computed by the API based on the detected one or more application-specific metrics. The health parameter may be indicative of health level of the corresponding application. Information corresponding to the one or more application-specific metrics and the computed health parameters for each of the plurality of applications may be transmitted by the API. The information corresponding to the one or more application-specific metrics and the computed health parameters for each of the plurality of applications may be retrieved by a processing unit. The retrieved information corresponding to each of the plurality of applications may be aggregated by the processing unit. The retrieved information may be processed by the processing unit to assess health each of the plurality of stations. A health dashboard may be generated by the processing unit. The method may include display, by the processing unit, the assessed health of each of the plurality of stations and at least one interactive element corresponding to the one or more application-specific metrics to manage and optimize performance using the health dashboard.

The method may include transmitting, by the API, a configuration link associated with each of the one or more application-specific metrics of each of the plurality of applications. The configuration link may facilitate modification of settings corresponding to the application-specific metric of the application. The assessed health of each of the plurality of stations may be displayed by the processing unit. The configuration links may correspond to each of the one or more application-specific metrics of each of the plurality of the applications using the health dashboard.

In an example, a health parameter corresponding to each of the one or more application-specific metrics may be computed, by the API, based on a comparison with a threshold corresponding to each of the one or more application-specific metrics. In an example, the method may include receiving, by the processing unit, inputs corresponding to selection of the at least one interactive element for each of the plurality of applications using the health dashboard. Access to detailed health information corresponding to each of the plurality of applications may be provided by the processing unit in response to the selection of the at least one interactive element using the health dashboard. In an example, the method may include displaying, by the processing unit, the assessed health corresponding to each of the one or more application-specific metrics as a numeric score and/or a colour-coding using the health dashboard.

In an example, a non-transitory computer-readable medium may comprise instructions for monitoring station health in a data integration framework. The instructions may be executable by a processing resource to provide an API implementable by each of a plurality of applications within the data integration framework. The data integration framework may include a plurality of stations. Each station may correspond to one or more computing devices operating within the data integration framework. Each of the plurality of applications may correspond to a station of the plurality of stations. The instructions may be executable by the processing resource to detect, via the API, one or more application-specific metrics of each of the plurality of applications. The one or more application-specific metrics may be indicative of performance and/or configuration of the application. The one or more application-specific metrics may be dynamically determinable by each application. The instructions may be executable by the processing resource to compute, via the API, a health parameter corresponding to each of the one or more application-specific metrics based on the detected one or more application-specific metrics. The health parameter may be indicative of health level of the corresponding application. The instructions may be executable by the processing resource to retrieve, via the API, information corresponding to the one or more application-specific metrics, the computed health parameters for each of the plurality of applications, and a configuration link associated with each of the one or more application-specific metrics of each of the plurality of applications. The configuration link may facilitate modification of settings corresponding to the application-specific metric of the application. The instructions may be executable by the processing resource to aggregate the retrieved information corresponding to each of the plurality of applications and process the retrieved information to assess health each of the plurality of stations. The instructions may be executable by the processing resource to display, using a GUI the assessed health of each of the plurality of stations, the configuration links corresponding to each of the one or more application-specific metrics of each of the plurality of applications to manage and optimize performance, and an interactive element corresponding to each of the one or more application-specific metrics of each of the plurality of applications to provide access to detailed health information corresponding to each of the plurality of applications in response to a selection of the interactive element.

In an example, the instructions being executable by the processing resource to query, by a station health service, the data integration framework for the plurality of applications that has implemented the API and detect, via the API, the one or more application-specific metrics of each of the plurality of applications based on the querying.

The instructions may be executable by the processing resource to receive, via the API, a threshold corresponding to each of the one or more application-specific metrics. The instructions may be executable by the processing resource to compare, via the API, each of the one or more application-specific metrics and the corresponding threshold. The instructions may be executable by the processing resource to compute, via the API, the health parameter corresponding to each of the one or more application-specific metrics based on the comparison.

In an example, the instructions being executable by the processing resource to allow, via the API, each of the plurality of applications to define the one or more application-specific metrics and a description corresponding to each of the one or more application-specific metrics. Further, the instructions may be executable by the processing resource to detect, via the API, the one or more application-specific metrics corresponding to each of the plurality of applications based on the defining of the one or more application-specific metrics by each of the plurality of applications.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for monitoring station health in a data integration framework, according to an example implementation of the present subject matter.

FIG. 2 illustrates a system for monitoring station health in a data integration framework, according to an example implementation of the present subject matter.

FIG. 3 illustrates a system for monitoring station health in a data integration framework, according to an example implementation of the present subject matter.

FIG. 4a-4b illustrate a method for monitoring station health in a data integration framework, according to an example implementation of the present subject matter.

FIG. 5 illustrates a method for monitoring station health in a data integration framework, according to an example implementation of the present subject matter.

FIG. 6 illustrates a method for monitoring station health in a data integration framework, according to an example implementation of the present subject matter.

FIGS. 7a-7b illustrate a method for monitoring station health in a data integration framework, according to an example implementation of the present subject matter and

FIGS. 8a-8b illustrate a computing environment, implementing a non-transitory computer-readable medium for monitoring station health in a data integration framework, according to an example implementation of the present subject matter.

### DETAILED DESCRIPTION

Generally, organizations employ various devices, Internet-of-Things (IoT)-based sensors, controllers, IoT-based electrical appliances, IoT-based cameras, and the like, on their premises (i.e., at a facility, such as a warehouse of the organization) that are interconnected through software platforms, such as Niagara platform and the like. Conventionally, the data integration frameworks may facilitate connectivity of the devices through numerous applications. In this regard, such data integration frameworks may include a core component that runs applications corresponding to the interconnected devices. The core component may be referred to as the stations. The health of the stations and the applications run by the core components may have to be monitored continuously to ensure optimal performance and optimal configuration of the applications and the interconnected devices. For instance, in a warehouse of an organization, the interaction between various IoT-based inventory tracking sensors and various controllers may be facilitated by the data integration platform through various applications. The performance of applications corresponding to the sensors and the controllers might arise and thereby, affecting the performance of the sensors and the controllers. Accordingly, to ensure optimal performance, the health of the stations and the applications may have to be monitored continuously.

Conventionally, the monitoring of station health is based on a high-level observability of various metrics, such as CPU usage, network traffic, memory consumption, disk utilization, and the like. However, such high-level monitoring of station health may not adequately capture the health and configuration status of stations and applications within the data integration framework. For example, a station might show normal CPU and memory usage, but a critical service could be malfunctioning. This may not be captured in high-level observability of the metrics. Further, the conventional monitoring of health are not application-specific, instead, are general. For instance, performance of one application may be indicated by one set of metrics while performance of another application may be indicated by a totally different set of metrics. Such application-specific insights may not be provided by the conventional monitoring of station health.

Conventional monitoring solutions have issues with respect to scalability. As the systems grow, there may be installation of new applications, such as third-party applications. The installation of such new applications may require update of the software platforms to monitor the metrics corresponding to the newly-installed application. This makes the process complex and time-consuming. Further, when there are issues corresponding to the applications, it may not be readily identified from the conventional monitoring solutions. Instead, system integrators may have to manually identify the issue. Accordingly, the conventional techniques depend on the expertise of system integrators to identify the problem. The process becomes difficult and complex, especially in cases where new third-party applications are installed.

As mentioned above, the conventional monitoring solutions are based on high-level observability of metrics. Accordingly, the conventional techniques are designed for a fixed set of metrics and device types. As new technologies are introduced, such as new IoT-based devices, AI-driven controllers, and the like, the conventional monitoring techniques do not adapt to such new technologies. With the conventional monitoring techniques, optimal configurations of applications are not easily clear. Therefore, there is a likelihood that system integrators may set up stations in ways that lead to poor performance or excessive resource consumption. The misconfigurations in the applications can be difficult to identify and correct without application-specific knowledge.

The present subject matter facilitates monitoring station health in data integration framework. With the present subject matter, health of station in a data integration framework can be monitored efficiently. Unlike the conventional approaches, the present subject matter provides application-specific monitoring. Therefore, the present subject matter provides appropriate insights into the performance of each application. In addition, the present subject matter also provides configuration link corresponding to the application-specific metric to modify settings that influence the corresponding application-specific metric. The present subject matter is flexible and allows monitoring of newly-installed applications, such as third-party applications, without requiring any update.

In an example, the present subject matter relates to techniques for monitoring station health in a data integration framework. The data integration framework may be, for example, Niagara platform. The data integration framework may facilitate connection of various computing devices, such as IOT-based sensors, controllers, and the like. The connection of such computing devices may be performed using various applications. In an example, the data integration framework may include a plurality of stations. Each station may correspond to one or more interconnected computing devices operating within the data integration framework. Each of the applications may correspond to a station of the plurality of stations. An Application Programming Interface (API) may be provided to each of the plurality of applications. The API may be implementable by each application. The implementation of the API by each application may allow each application to report one or more application-specific metrics dynamically. In addition, the implementation of the API may allow each of the plurality of applications to define a description corresponding to each of the one or more application-specific metrics.

Accordingly, the one or more application-specific metrics are dynamically determinable by each application. The application-specific metrics may be indicative of the performance and/or configuration of the application. For instance, assume that the data integration framework is a Niagara framework and the application may correspond to the history application. The history application, by implementing the API, may report number of histories collected corresponding to a plurality of computing devices, a collection interval, and the like.

In this regard, one or more application-specific metrics of each of the plurality of applications may be detected via the API. For the detection, the data integration framework may be queried by the station health service for the plurality of applications that has implemented the API and the detection may be performed based on the querying.

In an example, the present subject matter may allow detection of metric of newly installed applications without requiring update of the API or the data integration framework. In this regard, installation of a new application to the data integration framework may be detected. In response to the detection, the API may be provided to the new Application. The provision of the API to the new application allows plugging of the application for monitoring station health. Subsequently, one or more application-specific metrics of the new Application also may be detected. The one or more application-specific metrics of the new application is indicative of at least one of: performance and configuration of the new Application.

Upon the detection, a health parameter corresponding to each of the one or more application-specific metrics based on the detected metrics may be computed via the API. The health parameter may be computed based on a comparison with a threshold. For instance, for each of the one or more application-specific metrics, a threshold may be obtained. The application-specific metrics and the corresponding threshold may be compared to obtain the health parameter. The health parameter may be indicative of health level of the corresponding application. For instance, assume that an alarm application is used in Niagara platform. The alarm application is used for routing alarms to different computing devices, different users, and the like. In an example, assume that a high number, such as 2000, of routing configuration may have been set up in the alarm application. Further assume that the threshold routing configurations may be 100. Accordingly, the health parameter may be computed by comparing routing configurations (2000) with the threshold routing configuration (100).

In an example, information corresponding to the one or more application-specific metrics and the computed health parameters for each of the plurality of applications may be retrieved via the API. The retrieved information corresponding to each of the plurality of applications may be aggregated and processed. The processing of the retrieved information may be performed to assess health of each of the plurality of stations. For instance, the aggregation and the processing may involve combining application-specific metrics from multiple applications such as history, alarm, and network communications to determine a station's overall health status.

The assessed health of each of the plurality of stations may be displayed using a Graphical User Interface (GUI). The GUI may be a health dashboard. The health dashboard may be generated and updated dynamically. In an example, the assessed health may be displayed as a single graphic. In addition, the health dashboard may include at least one interactive element corresponding to the one or more application-specific metrics to manage and optimize performance. In an example, the at least one interactive element may be, for example, configuration links corresponding to each of the one or more application-specific metrics of each of the plurality of applications to manage and optimize performance. The health dashboard may include an interactive element corresponding to each of the one or more application-specific metrics of each of the plurality of applications to provide access to the detailed health information corresponding to each application. The assessed health may be represented by way of a categorical assessment, such as the health being good or bad, by way of a numeric score on an integer scale or by way of a colour-coding.

The present subject matter allows the applications to report their own application-specific metrics and optimal configurations and/or performance parameters. Therefore, the present subject matter enables provision of deeper, meaningful, and application-specific insights into application performance instead of generic system-wide metrics. The present subject matter helps system integrators to identify and resolve configuration issues before delivering to end customers, and therefore, improving overall product quality of the data integration framework. The present subject matter allows monitoring of health of newly installed applications without requiring any update. Therefore, the present subject matter is easily scalable. By providing configuration links along with metrics, the present subject matter enables users to quickly address issues and optimize performance. The representation of the health by way of numeric score, colour coding or categorical assessment allows for easy interpretation of health across different applications. With the present subject matter, health of station in a data integration framework can be monitored efficiently. Unlike the conventional approaches, the present subject matter provides application-specific monitoring. Therefore, the present subject matter provides appropriate insights into the performance and/or configuration of each application.

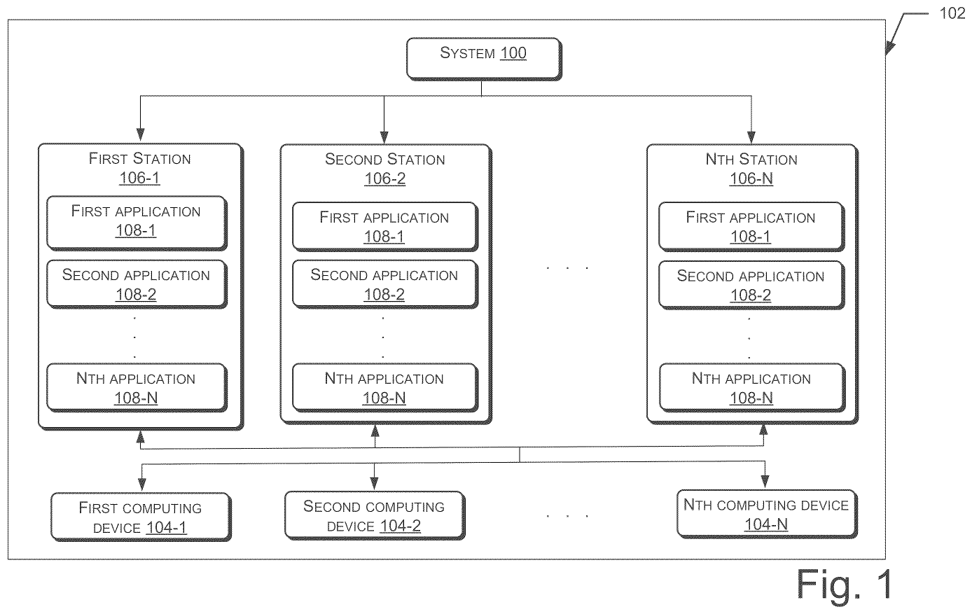

The present subject matter is further described with reference to FIGS. 1-8b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for monitoring station health in data integration framework 102, according to an example implementation of the present subject matter. In an organization, such as manufacturing unit, industrial plant, and the like, numerous computing devices, such as a first computing device 104-1, a second computing device 104-2, . . . , a N^{th} computing device 104-N, are employed. Hereinafter, the computing devices may also be collectively referred to as computing devices 104. The computing devices 104 may be, for example, Internet-of-Things (IoT)-based sensors, controllers, IoT-based electrical appliances, IoT-based cameras, and the like. The computing devices 104 may be interconnected by the data integration framework 102. The interconnection of the computing device 104 is done to manage the operations of the computing devices 104, monitoring performance of the computing devices 104, and the like. The interconnection through the data integration framework 102 may enable provision of unified interfaces and functionality for users. In an example, the data integration framework 102 may be Niagara platform. Since the computing devices 104 are interconnected using the data integration framework 102, in the view depicted herein, the data integration framework 102 is shown to include the computing devices 104.

The data integration framework 102 may facilitate connectivity of the computing devices 104 through a plurality of applications, such as a first application 108-1, a second application 108-2, . . . , N^{th} application 108-N. Each of these applications 108 may correspond to each of the computing devices 104. For instance, the first application 108-1, the second application 108-2, . . . , N^{th} application 108-N may control the computing devices 104, manage operations of the computing devices 104, provide interfaces corresponding to controlling of the computing devices 104, and the like. The applications 108 may be, for example, history application, alarm application, events application, heartbeat application, messaging application, and the like. The history application may correspond to historical collection of live data of the computing devices 104. The alarm application may correspond to an abnormal event associated with the computing devices 104. The events application may correspond to events other than abnormal events associated with the computing devices 104. The heartbeat application may correspond to health information of the computing devices 104. The messaging application may correspond to an arbitrary message from the computing devices 104.

The data integration framework 102 may include a plurality of core components that run the applications 108 corresponding to the computing devices 104. The core components may be referred to as the stations. In an example, the data integration framework 102 may include a first station 106-1, a second station 106-2, . . . , N^{th} station 106-N. The station may be collectively referred to as the stations 106. The health of the stations 106 and the applications 108 run by the stations 106 may have to be monitored continuously to ensure optimal performance and optimal configuration of the applications 108 and the computing devices 104.

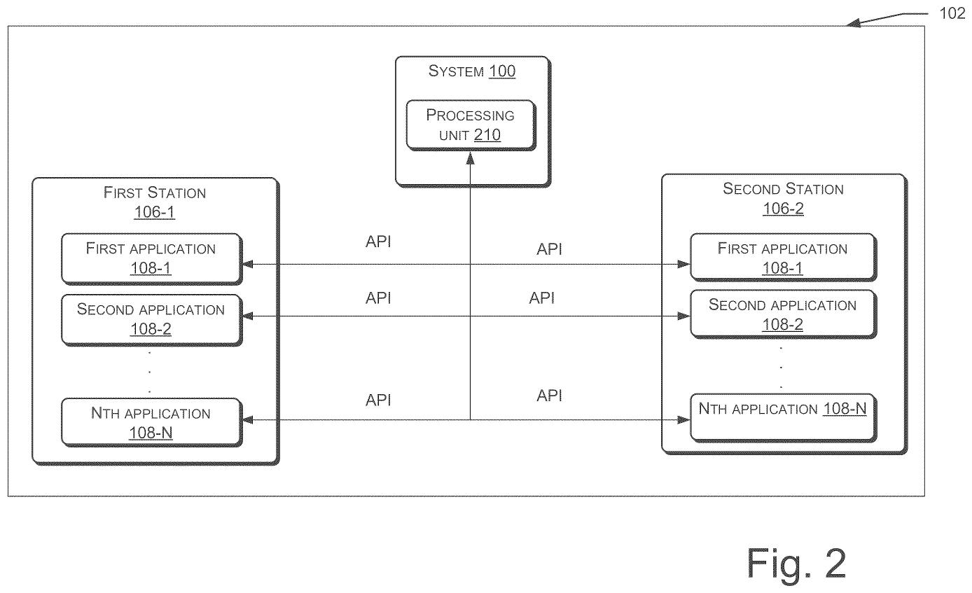

In this regard, the system 100 may monitor the health of the stations 106. The system 100 may be part of the data integration framework 102 and therefore, the system 100 is shown to be included in the data integration framework 102. The system 100 may include a microprocessor, a microcomputer, a microcontroller, a digital signal processor, a central processing unit, a state machine, a logic circuitry, or a device that manipulates signals based on operational instructions. Among other capabilities, the system 100 may fetch and execute computer-readable instructions stored in a memory, such as a volatile memory or a non-volatile memory, of the system 100. The system 100 may include a device (not shown in FIG. 1), such as a display device, for displaying various things, as will be explained later, corresponding to health data of stations. The operation of the system 100 will be explained with reference to FIG. 2.

FIG. 2 illustrates the system 100 for monitoring station health in a data integration framework 102, according to an example implementation of the present subject matter. In the view depicted herein, the computing devices 104 are not shown. Further, only the first station 106-1 and the second station 106-2 are depicted out of the plurality of stations 106. The system 100 may include a processing unit 210. The processing unit 210 may include a microprocessor, a microcomputer, a microcontroller, a digital signal processor, a central processing unit, a state machine, a logic circuitry, or a device that manipulates signals based on operational instructions. Among other capabilities, the processing unit 210 may fetch and execute computer-readable instructions stored in a memory, such as a volatile memory or a non-volatile memory, of the processing unit 210. The data integration framework 102 may correspond to the data integration framework 102.

During operation, the system 100 may provide Application Programming Interface (API) to each of the plurality of applications 108. The API may be implementable by the applications 108. The implementation of the API by each application 108 may allow each application 108 to report one or more application-specific metrics dynamically. In addition, the implementation of the API may allow each of the plurality of applications 108 to define a description corresponding to each of the one or more application-specific metrics. The system 100 may dynamically determine the one or more application-specific metrics by each application 108. The application-specific metrics may be indicative of the performance and/or configuration of the applications 108. For instance, assume that the first application 108-1 corresponds to the history application. The history application, by implementing the API, may report number of histories collected corresponding to the computing devices 104, a collection interval, and the like.

In this regard, the system 100 may detect one or more application-specific metrics of each of the plurality of applications 108 via the API. The application-specific metrics may be, for example, routing configuration corresponding to alarm application, number of histories collected corresponding to history application, collection interval of histories corresponding to history application, and the like. For the detection, the system 100 may query the data integration framework 102 by a station health service (not shown in FIG. 2) for the plurality of applications 108 that has implemented the API. The detection of the one or more application-specific metrics may be performed based on the querying.

In an example, the system 100 may allow detection of metric of newly installed applications without requiring update of the API or the data integration framework 102. In this regard, installation of a new application to the data integration framework 102 may be detected by the system 100. In response to the detection, the system 100 may provide API to the new Application. The provision of the API to the new application allows plugging of the application for monitoring station health. Subsequently, one or more application-specific metrics of the new Application also may be detected. The one or more application-specific metrics of the new application is indicative of at least one of: performance and configuration of the new Application.

In response to the detection, the system 100 may compute a health parameter corresponding to each of the one or more application-specific metrics based on the detected metrics, The computation of health parameters may be performed using the API. The health parameter may be indicative of health level of the corresponding application. The system 100 may retrieve information corresponding to the one or more application-specific metrics and the computed health parameters for each of the plurality of applications 108 via the API. The system 100 may aggregate and process the retrieved information corresponding to each of the plurality of applications 108. The processing of the retrieved information may be performed to assess health of each of the plurality of stations 106.

The system 100 may display, using a Graphical User Interface (GUI), the assessed health of each of the plurality of stations 106. The GUI may be a health dashboard. The system 100 may generate the health dashboard and update the health dashboard dynamically. The health dashboard may include at least one interactive element corresponding to the one or more application-specific metrics to manage and optimize performance. The at least one interactive element may be, for example, configuration links corresponding to each of the one or more application-specific metrics of each of the plurality of applications 108 to manage and optimize performance. The health dashboard may include an interactive element corresponding to each of the one or more application-specific metrics of each of the plurality of applications 108 to provide access to the detailed health information corresponding to each application 108. The assessed health may be represented by way of a categorical assessment, such as the health being good or bad, by way of a numeric score on an integer scale or by way of a colour-coding. As will be understood, the above-mentioned functions of the system 100 may be performed by the processing unit 210.

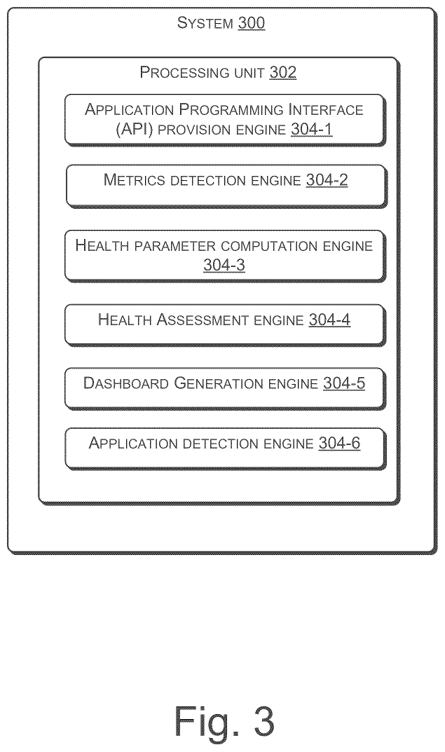

FIG. 3 illustrates a system 300 for monitoring station health in a data integration framework, according to an example implementation of the present subject matter. The system 300 may correspond to the system 100. The data integration framework may correspond to the data integration framework 102. The data integration framework may include a plurality of stations that correspond to the stations 106. The stations may include a plurality of applications, that correspond to the applications 108. The data integration framework may enable interconnection of the computing devices, that correspond to the computing devices 104.

The system 300 may be a computing device that has processing capabilities, such as a server, a desktop, a laptop, a tablet, a mobile phone, or the like. For instance, the system 300 may include a processing unit 302. The processing unit 302 may be, for example, a microprocessor, a microcomputer, a microcontroller, a digital signal processor, a central processing unit, a state machine, a logic circuitry, or a device that manipulates signals based on operational instructions. Among other capabilities, the processing unit 302 may fetch and execute computer-readable instructions stored in a memory (not shown in FIG. 3), such as a volatile memory or a non-volatile memory, of the system 300. The processing unit 302 may correspond to the processing unit 210.

The processing unit 302 may run at least one operating system and other applications and services, such as a station health service. The system 300 can also include an interface (not shown in FIG. 3) and a memory (not shown in FIG. 3). The processing unit 302, amongst other capabilities, may be configured to fetch and execute computer-readable instructions stored in the memory. The processing unit 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 302, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 302. Further, the interface may enable the components of the system 300 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory may be coupled to the processing unit 302 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. Further, the system 300 may include a display device. The display device may correspond to the display device of the system 100.

Further, the system 300 may include one or more engines 304-1-304-6. The engines 304-1-304-6 may include routines, programs, objects, components, data structures, and the like, which perform particular tasks or implement particular abstract data types. Further, the engines 304-1-304-6 may be implemented in hardware, instructions executed by a processing unit, or by a combination thereof.

In an implementation, the engines 304-1-304-6 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 304-1-304-6 may perform different functionalities. The engines 304-1-304-6 may include an API provision engine 304-1, a metrics detection engine 304-2, a health parameter computation engine 304-3, a health assessment engine 304-4, a dashboard generation engine 304-5, and an application detection engine 304-6.

The API provision engine 304-1 may enable provision of the API to the applications. The application may implement the API received to facilitate detection of the one or more application specific metrics. In some examples, the new applications may be installed to the data integration framework. In such examples, the API provision engine 304-1 may provide the new application also. The new application may facilitate detection of the one or more application-specific metrics of the new application in response to the implementation of the API.

The metrics detection engine 304-2 may detect the one or more application-specific metrics of each of the plurality of applications. In this regard, the metrics detection engine 304-2 may allow each of the plurality of applications to define the one or more application-specific metrics and a description correspond to each of the one or more application-specific metrics via the API. Further, the metrics detection engine 304-2 may also allow provision of configuration links corresponding to each of the one or more application-specific metrics of each application via the API. The configuration links may facilitate modification of settings corresponding to the application-specific metric of the application.

In an example, the metrics detection engine 304-2 may query the data integration framework for the applications that have implemented the API. The querying may be performed using the station health service. Further, the metrics detection engine 304-2 may detect the one or more application specific metrics of each of the plurality of applications based on the querying. Further, the metrics detection engine 304-2 may detect the one or more application-specific metrics corresponding to each of the plurality of applications based on the defining of the one or more application-specific metrics by each of the plurality of applications. In an example, in response to the detection of the new application, the metric detection engine 304-2 may detect one or more application-specific metrics of the new applications.

The health parameter computation engine 304-3 may compute, via the API, a health parameter corresponding to each of the one or more application-specific metrics based on the detected one or more application-specific metrics. For the computation, the health parameter computation engine 304-3 may compare each of the one or more application-specific metric and a corresponding threshold. The threshold corresponding to each of the one or more application-specific metrics may be received via the API. Based on the comparison, the health parameter computation engine 304-3 may compute the health parameters corresponding to the one or more application-specific metrics.

The health assessment engine 304-4 may enable retrieval of the information corresponding to the one or more application-specific metrics and the computed health parameters of each application. Subsequently, the health assessment engine 304-4 may aggregate the retrieved information corresponding to each application and process the retrieved information to assess health of each station.

The dashboard generation engine 304-5 may display the health dashboard based on the assessed health. The assessed health may be represented as a categorical assessment, a numeric score, and/or a colour-coding. In addition, the dashboard generation engine 304-5 may display at least one interactive element corresponding to the one or more application-specific metrics to manage and optimize performance.

The at least one interactive element may include the configuration link received via the API. In this regard, the dashboard generation engine 304-5 may display the assessed health of each of the plurality of stations and the received configuration links corresponding to each of the one or more application-specific metrics of each of the plurality of the applications. In another example, the at least one interactive element may correspond to detailed health information corresponding to each of the plurality of applications. Accordingly, the dashboard generation engine 304-5 may provide access to the detailed information corresponding to each of the plurality of applications in response to selection of the at least one interactive element by a user.

The application detection engine 304-6 may detect installation of new applications to the data integration framework. Based on the detection of the new applications, the application detection engine 304-6 may coordinate with the API provision engine 304-1 to enable provision of the API to the new application.

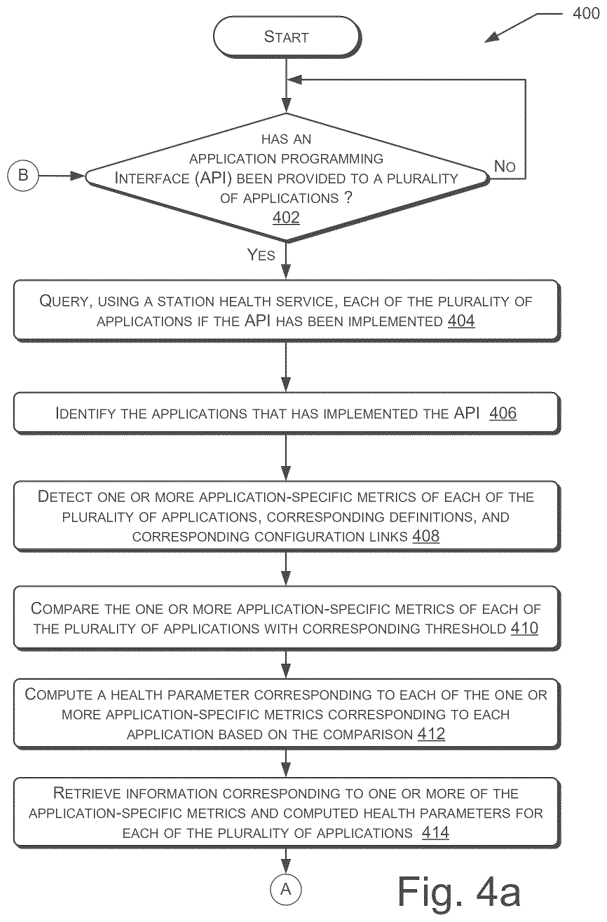

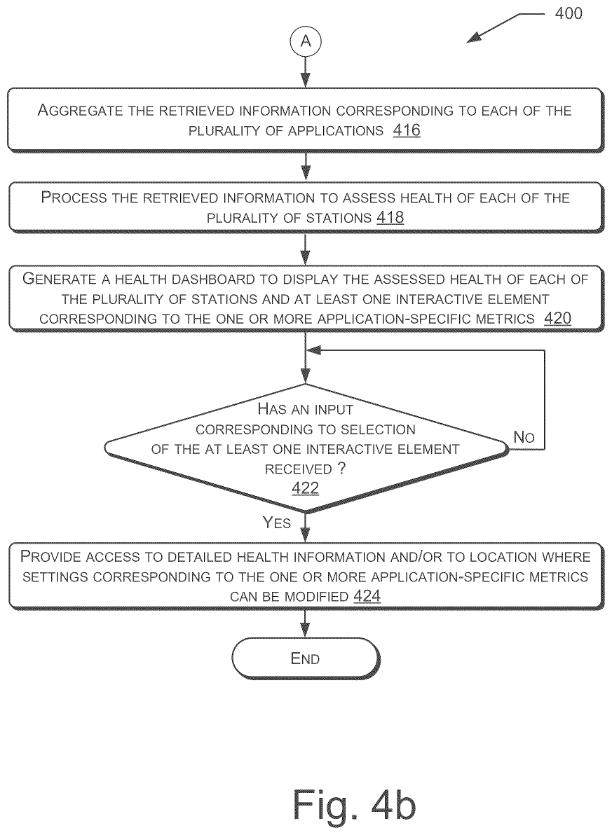

FIGS. 4a-4b illustrate a method 400 for monitoring station health in a data integration framework, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100 or the system 300. In particular, the method 400 may be performed by the processing unit 210 or the processing unit 302. The data integration framework may correspond to the data integration framework 102.

Referring to FIG. 4a, at step 402, it may be determined if an API has been provided to a plurality of applications. The plurality of applications may be run and managed by a plurality of stations of the data integration framework. The plurality of applications may correspond to the applications 108 and the plurality of stations may correspond to the stations 106. The plurality of stations may correspond to the computing devices. The computing devices may be, for example, the computing devices 104. The API may be implementable by each of the plurality of applications. For instance, assume the applications, such as alarm application and history application, correspond to a first station and to a second station. In this regard, it may be determined if the first application and the second application have been provided with the API. The API may be implementable by the alarm application and the history application.

The implementation of the API may allow each application to report one or more application-specific metrics dynamically. The application-specific metrics may be indicative of the performance and/or configuration of the applications. For instance, the implementation of the API by the alarm application may allow the alarm application to report application-specific metrics, such as the number of routing configurations, and the like. Further, the implementation may also allow the alarm application to provide a description about the number of routing configurations. Similarly, the implementation of the API by the history application may allow the history application to report application-specific metrics, such as the number of histories collected, collection interval, and the like. Further, the implementation may also allow the history application to provide a description about the number of histories collected, the collection interval, and the like.

In addition, in an example, the implementation of the API may allow the application to report configuration links corresponding to each of the one or more application-specific metrics. The configuration links may correspond to the application-specific metric and may facilitate modification of setting corresponding to the application-specific metrics of each application. For instance, the implementation of the API by the alarm application may allow reporting of the configuration link that provides access to modify number of routing configuration. Similarly, the implementation of the API by the history application may allow reporting a configuration link that provides access to modify the number of histories collected, a configuration link that provides access to modify the collection interval, and the like.

In this regard, the implementation of the API by the application may also allow reporting of a threshold corresponding to each application-specific metric. The threshold of each application-specific metric may be indicative of an optimal performance and/or optimal configuration of the application. For instance, in the alarm application, the threshold corresponding to number of routing configuration may be 100. In other words, 100 routing configurations may ensure optimal performance of the alarm application and the corresponding station. Similarly, in the history application, the threshold corresponding to number of histories collected may be 100. In other words, 100 histories may ensure optimal performance of the history application and the station corresponding to the history application. The threshold corresponding to collection interval may be 30 minutes, which may ensure optimal performance of the history application and the corresponding station.

If, at step 402, it is determined that the API has not been provided to the plurality of applications, then the method 400 will repeat the step 402. On the other hand, if it is determined that the API has been provided to the plurality of applications, the method 400 may proceed to step 404.

At step 404, each of the plurality of applications may be queried using a station health service as to whether the API has been implemented. For instance, the alarm application may be queried whether the API has been implemented. Similarly, the history application may be queried whether the API has been implemented. At step 406, the applications that have implemented the API may be identified. The station health service may identify that the each of the plurality of applications that have implemented the API based on the querying.

At step 408, the one or more application-specific metrics of each of the plurality of applications, corresponding definitions, and the corresponding configuration links may be detected by using the API. For example, based on the querying by the station health service, the one or more application-specific metrics of each of the plurality of applications, the corresponding definitions, and the corresponding configuration links. For instance, for the alarm applications, based on the querying, the number of routing configurations, the description thereof, and the corresponding configuration link to facilitate modification of the number of routing configuration may be detected. Similarly, for the history application, based on the querying, the number of histories collected, the description thereof, and the corresponding configuration link to facilitate modification of the number of histories collected, the collection interval, the description thereof, and the corresponding configuration link to facilitate modification of the collection interval, may be detected.

At step 410, the one or more application-specific metrics of each of the plurality of applications may be compared with a corresponding threshold using the API. For instance, assume that in the alarm application, the number of routing configurations is 2000 and the corresponding threshold is 100. In this regard, the number of routing configurations (2000) may be compared with the threshold of 100. Similarly, assume that the number of histories collected is 1000 and the threshold number of histories collected is 100. In this regard, the number of histories collected (1000) may be compared with the threshold (100). Further, assume that the collection interval is 45 minutes and the threshold collection interval is 30 minutes. In this regard, the collection interval (45 minutes) may be compared with the threshold collection interval (30 minutes). For the comparison, it may be identified if the one or more application-specific metrics of each of the plurality of applications may be greater or not greater than the corresponding threshold.

At step 412, a health parameter corresponding to each of the plurality of application-specific metrics corresponding to each application may be computed. The computation of the health parameter may be performed based on the comparison using the API. The health parameter may be indicative of a health level of the application. For instance, based on the comparison, it may be identified if the application-specific metric is greater than a threshold or not greater than a threshold and may compute the health parameter based on the identification. For each application-specific metric, the computation may be different. For instance, for some application-specific metrics, if the application-specific metric is greater than the corresponding threshold, the performance and/or the configuration may be deemed optimal. If the application-specific metric is not greater than the corresponding threshold, the performance and/or the configuration may be deemed non-optimal. On the other hand, for some application-specific metrics, if the application-specific metric is not greater than the corresponding threshold, the performance and/or the configuration may be deemed optimal. If the application-specific metric is greater than the corresponding threshold, the performance and/or the configuration may be deemed non-optimal. Accordingly, for each application-specific metric, the computation of the health parameter may be based on the identification of whether the application-specific metric is greater than or not greater than the threshold and based on the optimality and non-optimality in the performance and/or configuration.

In an example, the health parameter may be a numeric score on an integer scale assigned based on the comparison. In particular, the health parameter may be assigned a numeric score on the scale of 1-10 based on the comparison with the numeric score of ‘10’ indicating good health level and the numeric score of ‘1’ indicating a poor health level. For instance, assume that the threshold number of routing configurations is ‘100’. If the number of routing configurations is less than 100, it will indicate better health and if the number of routing configurations is more than 100, it will indicate relatively lesser health. The farther the number of routing configuration more than 100 may indicate the health parameter of the alarm application relatively lesser. Assume that the number of routing configurations is 1000. It may be determined that the number of routing configurations is greater than the threshold (100) and may compute the health parameter as, for example, 1. This is because the number of routing configuration is far higher than the threshold. Assume that the number of routing configurations is 200. It may be determined that the number of routing configurations is greater than the threshold (100) and may compute the health parameter as, for example, 3. This is because the number of routing configuration is a little higher than the threshold. Similarly, the farther the number of routing configurations less than 100 may indicate the health parameter of the alarm application is relatively higher. Assume that the number of routing configurations is 50. It may be determined that the number of routing configurations is lesser than the threshold (100) and may compute the health parameter as, for example, 8. Assume that the number of routing configurations is 10. It may be determined that the number of routing configurations is far lesser than the threshold (100) and may compute the health parameter as, for example, 9. In an example, the numeric score may be assigned based on ranges. For instance, if the number of routing configurations is between 1 and 30, then the numeric score of 10 may be assigned. Similarly, if the number of routing configurations is between 100 and 200, then the numeric score of 4 may be assigned, and the like.

In another example, the health parameter may be a categorical assessment and may indicate if the health parameter is good, bad, or fine. For instance, if the number of routing configurations is higher than the threshold number of routing configurations, the health parameter may be computed as ‘bad’. If the number of routing configurations is equal to the threshold number of routing configurations, the health parameter may be computed as ‘fine’. If the number of routing configurations is lesser than the threshold number of routing configurations, the health parameter may be computed as ‘good’.

In yet another example, the health parameter may be assigned as colour-coding with each colour indicating a health level of the application. For instance, in some scenarios, if the application-specific metric is less than the threshold, then a specific colour may be provided. If the application-specific metric is equal to the threshold, another colour may be provided. If the application-specific metric is lesser than the threshold, then yet another colour may be provided. The colour may be intuitive and also be provided with a ‘legend’ explaining the significance of the colour with respect to the health parameter.

At step 414, information corresponding to the one or more application-specific metrics and the computed health parameters for each of the plurality of applications may be retrieved using the API. For instance, for the alarm application, the number of routing configurations and the health parameter corresponding to the number of routing configurations may be retrieved using the API. Similarly, for the history application, the number of histories collected, the health parameter corresponding to the number of histories collected, the collection interval, and the health parameter corresponding to the collection interval may be retrieved using the API. Further, the method 400 may proceed to step 416 through ‘A’.

Referring to FIG. 4b, at step 416, the retrieved information corresponding to each of the plurality of applications may be aggregated. For instance, the retrieved information from the alarm application and the retrieved information from the history application may be aggregated. At step 418, the retrieved information may be processed to assess the health of each of the plurality of stations. For instance, the retrieved information corresponding to the alarm application and the retrieved information corresponding to the history application may be processed. The processing may include consolidating the health parameter corresponding to each of the plurality of application corresponding to each station. In other words, the health parameter of the alarm application and the history application corresponding to the first station may be consolidated. Similarly, the health parameter of the alarm application and the history application corresponding to the second station may be consolidated. The consolidation may facilitate assessment of health of each of the plurality of stations.

At step 420, a Graphical User Interface (GUI) may be generated. The GUI may be a health dashboard. The health dashboard may be used to display the assessed health of each of the plurality of stations. For instance, corresponding to each station, the health dashboard may display the health parameters corresponding to each of the plurality of application-specific metrics of each application and the assessed health of each station. In other words, the health dashboard may display the health parameter for each application-specific metric as the categorical assessment, the numeric score, the colour-coding, or a combination thereof. Based on the health parameter, the health dashboard may display the assessed health of each station. For instance, for the first station, the health dashboard may display the health parameter corresponding to the number of routing configurations (alarm application), the health parameter corresponding to the number of histories collected (history application), the health parameter corresponding to the collection interval (history application), and the assessed health based on the health parameters of the alarm application and based on the health parameters of the history application. Similarly, for the second station, the health dashboard may display the health parameter corresponding to the number of routing configurations (alarm application), the health parameter corresponding to the number of histories collected (history application), the health parameter corresponding to the collection interval (history application), and the assessed health based on the health parameters of the alarm application and based on the health parameters of the history application.

In addition, the health dashboard may include at least one interactive element corresponding to the one or more application-specific metrics. In an example, the at least one interactive element may correspond to configuration link for each of the one or more application-specific metrics. For example, the health dashboard may include a configuration link corresponding to the number of routing configuration, a configuration link corresponding to the number of histories collected, and a configuration link corresponding to the collection interval. The configuration link corresponding to the number of routing configuration may facilitate a user to modify the setting corresponding to the number of routing configurations. The configuration link corresponding to the number of histories collected may facilitate a user to modify the setting corresponding to the number of histories collected. The configuration link corresponding to the collection interval may facilitate a user to modify the setting corresponding to the collection interval. Accordingly, when the health parameter is abnormal, the configuration link may be used by the user to modify and bring the health parameter to normal. The configuration links may be provided for each application-specific metric corresponding to each application for each of the plurality of stations.

In another example, the at least one interactive element may include a link which may provide access to the detailed health information corresponding to each of the application-specific metrics of each application for each of the plurality of stations. The detailed health information may include description of each of the one or more application-specific metrics and threshold corresponding to each of the one or more application-specific metrics. In some scenarios, the detailed health information may also include recommendations to improve the health parameter corresponding to the one or more application-specific metrics. In some scenarios, the detailed health information may also include how much further the application-specific metrics can be used while also maintaining performance and/or configuration of the application without deterioration. In an example, the health dashboard may be displayed on a display device. The display device may correspond to the display device of the system 100 or the system 300. Further, in some examples, the display device may facilitate receiving inputs from a user.

At step 422, it may be determined if an input corresponding to selection of the at least one interactive element has been received. For instance, a user may select a configuration link corresponding to the application-specific metrics. The user may wish to access detailed health information corresponding to the application-specific metrics and therefore, may select the at least one interactive element. At step 422, if it is determined that the input has been received, the method 400 may proceed to step 424. On the other hand, if it is determined that the input has not been received, the method 400 may repeat the step 422.

At step 424, based on the input, access to the detailed health information may be provided and/or access to a location where setting corresponding to the one or more application-specific metrics may be modified may be provided. For instance, if the user selects the interactive element that corresponds to a configuration link of an application-specific metric, then the access to a location where the settings corresponding to the one or more application-specific metrics may be modified may be provided. The user may use that to modify the setting corresponding to the application-specific metrics. For instance, if the user may have to modify the setting corresponding to the number of routing configurations (alarm application), the user may select the configuration link corresponding to the number of routing configurations. Based on the input, access to a location where the setting corresponding to the number of routing configurations can be modified may be provided. If the user selects the interactive element that corresponds to detailed health information of the application-specific metric, then the access to the detailed health information corresponding to the application-specific metric may be provided. For instance, if the user may have to know the further information corresponding to number of routing configurations (alarm application), the user may select the interactive element corresponding to the number of routing configurations that provides the detailed health information. Based on the input, the detailed health information corresponding to the number of routing configurations may be provided.

In an example, new applications, such as third-party applications, may be installed in the data integration framework. In such scenarios, the present subject matter allows monitoring of health without requiring any update to the data integration framework or the API, as will be explained below.

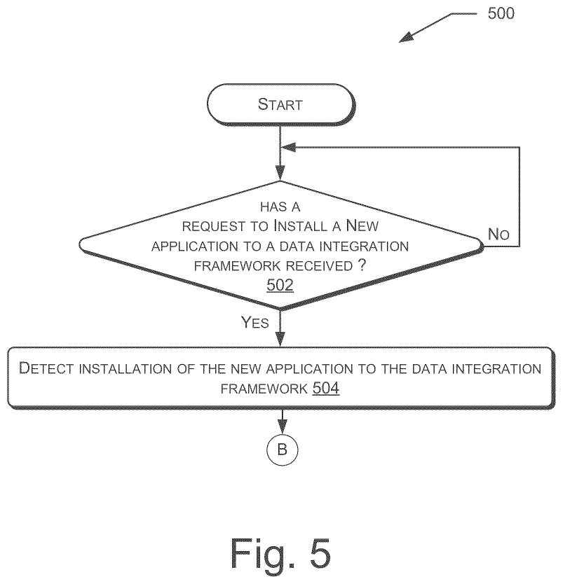

FIG. 5 illustrates a method 500 for monitoring station health in a data integration framework, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100 or the system 300. In particular, the method 500 may be performed by the processing unit 210 or the processing unit 302. The data integration framework may correspond to the data integration framework 102. The data integration framework may include a plurality of stations to run and manage a plurality of applications. The plurality of applications may correspond to the applications 108 and the plurality of stations may correspond to the stations 106. The plurality of stations may correspond to the computing devices. The computing devices may be, for example, the computing devices 104.

At step 502, it may be identified if a request to install a new application to a data integration framework is received. For instance, a third-party application may have to be installed onto the Niagara platform. In this regard, a request for the installation may be received by the Niagara platform. Accordingly, it may be identified if a request is received. At step 502, if the request has been received, the method 500 may proceed to the step 504. On the other hand, at step 502, if the request has not been received, the method 500 may repeat the step 502.

At step 504, the installation of the new application to the data integration framework may be detected. For instance, the installation of the third-party application onto the Niagara platform may be detected. In response to the detection, to monitor the station health, the method 500 may repeat the steps 402-424, as is indicated through ‘B’ in FIG. 5 and FIG. 4a. For the sake of brevity, the steps are not repeated here.

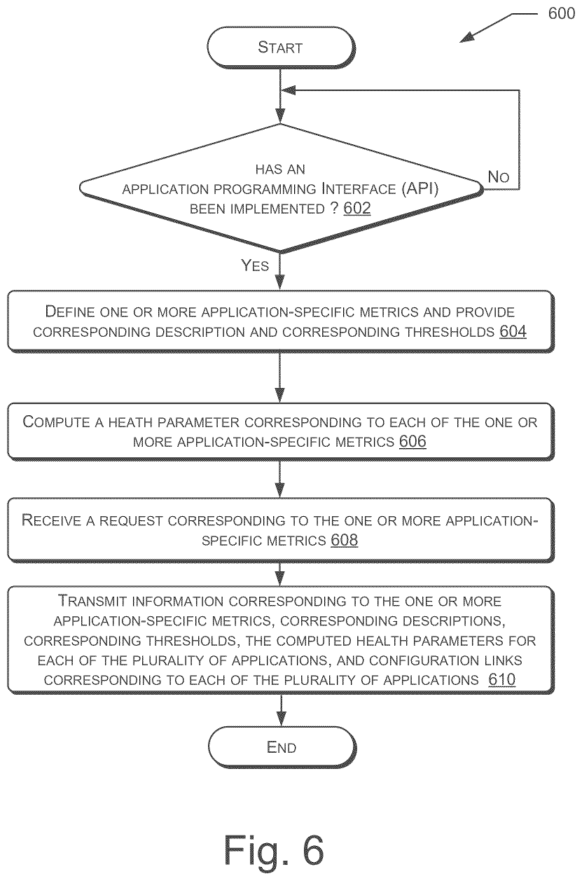

FIG. 6 illustrates a method 600 for monitoring station health in a data integration framework, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed partially by the applications, such as the applications 108, and by the API provided by a system, such as the system 100 or the system 300. The data integration framework may correspond to the data integration framework 102. The data integration framework may include a plurality of stations that run and manage the applications. The stations may be, for example, the stations 106. The stations may correspond to the computing devices, such as the computing devices 104.

At step 602, it may be determined if an API provided to the plurality of applications has been implemented. If, at step 602, it is determined that the API has not been implemented by the applications, then the method 600 will repeat the step 602. On the other hand, if it is determined that the API has been implemented by the plurality of applications, the method 600 may proceed to step 604.

At step 604, in response to the implementation, the API may allow defining one or more application-specific metrics by the applications. For instance, implementing the API, the applications can define the one or more application-specific metrics that may be indicative of the performance and/or configuration of the applications. For instance, assume an application, such as alarm application, may correspond to a first station and an application, such as history application, may correspond to a second station. In this regard, the implementation of the API by the alarm application of the first station may allow the alarm application to define the application-specific metrics, such as number of routing configurations. Similarly, the implementation of the API by the history application may allow the history application to define number of histories collected, collection interval, and the like. In addition, the applications may also provide a description corresponding to each of the one or more application-specific metrics. For instance, the alarm application may provide a definition corresponding to the number of routing configurations. Similarly, the history application may provide description about the number of histories collected and description about collection interval.

Further, in addition, the applications may also provide configuration links corresponding to each of the one or more application-specific metrics. The configuration links may correspond to the application-specific metric and may facilitate modification of setting corresponding to the application-specific metrics of each application. For instance, the alarm application may provide a configuration link that provides access to modify number of routing configurations. Similarly, the history application may provide a configuration link that provides access to modify the number of histories collected, a configuration link that provides access to modify the collection interval, and the like.

Further, the applications may provide a threshold corresponding to each application-specific metric. The threshold of each application-specific metric may be indicative of an optimal performance and/or optimal configuration of the application. For instance, in the alarm application, the threshold corresponding to the number of routing configuration may be 100. In other words, 100 routing configurations may ensure optimal performance of the alarm application and the corresponding station. Therefore, the alarm application may provide the threshold number of routing configurations. Similarly, in the history application, the threshold corresponding to number of histories collected may be 100. In other words, 100 histories may ensure optimal performance of the history application and the station corresponding to the history application. The threshold corresponding to collection interval may be 30 minutes, which may ensure optimal performance of the history application and the corresponding station. Therefore, the history application may provide the threshold number of histories collected and the threshold collection interval.

At step 606, a health parameter corresponding to each of the plurality of application-specific metrics corresponding to each application may be computed. The health parameter may be indicative of the health level of the application. The computation of the health parameter may be performed based on a comparison with the corresponding threshold. The one or more application-specific metrics of each of the plurality of applications may be compared with a corresponding threshold. For instance, assume that in the alarm application, the number of routing configurations is 2000. In this regard, the number of routing configurations (2000) may be compared with the threshold of 100. Similarly, assume that the number of histories collected is 1000. In this regard, the number of histories collected (1000) may be compared with the threshold (100). Further, assume that the collection interval is 45 minutes. In this regard, the collection interval (45 minutes) may be compared with the threshold collection interval (30 minutes). For the comparison, it may be identified if the one or more application-specific metrics of each of the plurality of applications may be greater or not greater than the corresponding threshold. Further, the applications may compute the health parameter based on the identification. For each application-specific metric, the computation may be different, as explained with reference to the step 412 of FIG. 4a. For instance, for some application-specific metrics, if the application-specific metric is greater than the corresponding threshold, the performance and/or the configuration may be deemed optimal. If the application-specific metric is not greater than the corresponding threshold, the performance and/or the configuration may be deemed non-optimal. On the other hand, for some application-specific metrics, if the application-specific metric is not greater than the corresponding threshold, the performance and/or the configuration may be deemed optimal. If the application-specific metric is greater than the corresponding threshold, the performance and/or the configuration may be deemed non-optimal. Accordingly, for each application-specific metric, the computation of the health parameter may be based on the identification of whether the application-specific metric is greater than or not greater than the threshold and based on the optimality and non-optimality in the performance and/or configuration. In an example, based on the comparison, the health parameter may be a numeric score on an integer scale, a categorical assessment, a colour-coding, or a combination thereof, as is explained with reference to step 412 of FIG. 4a.

At step 608, the applications may receive a request corresponding to the one or more application-specific metrics. For instance, a station health service may receive a request corresponding to the one or more application-specific metrics of each application. The request may include a query whether the application has implemented the API, as is explained with reference to step 404. Subsequently, the query may also include a request to transmit the defined application-specific metrics, corresponding description, corresponding thresholds, corresponding configuration links, and corresponding computed health parameters. At step 610, in response to receiving the request, each application may transmit information corresponding to the defined one or more application-specific metrics, the computed health parameters, the corresponding description, the corresponding thresholds, and the configuration links. For instance, the alarm application may transmit information corresponding to the number of routing configurations, the corresponding description, the threshold (100), the configuration link, and the computed health parameter.

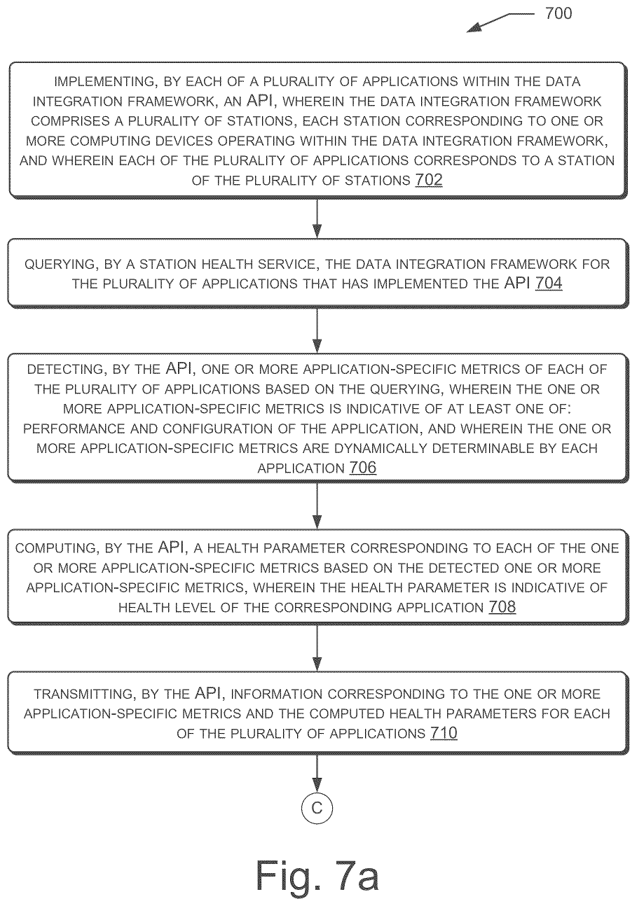

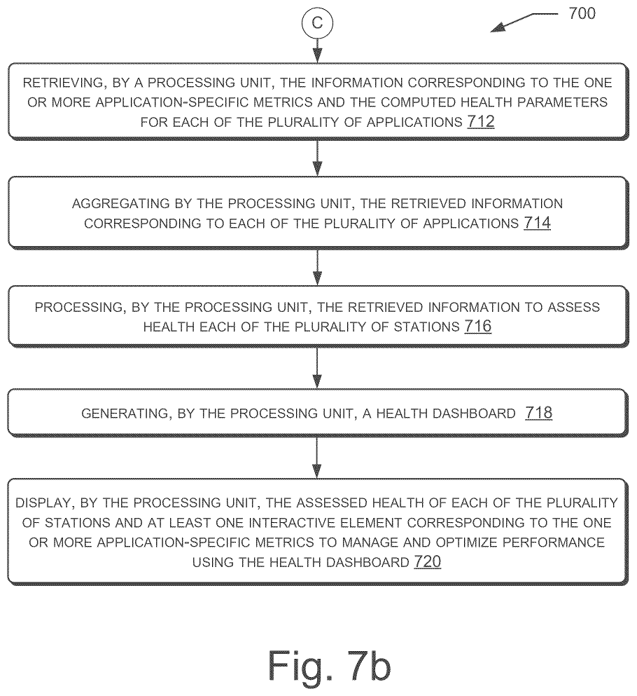

FIGS. 7a-7b illustrate a method 700 for monitoring station health in data integration framework, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 700 may be performed by the system 100 or the system 300. In particular, the method 700 may be performed by the processing unit, such as the processing unit 210 or the processing unit 302. The data integration framework may correspond to the data integration framework 102. The data integration framework may be, for example, Niagara platform.

Referring to FIG. 7a, at step 702, the method 700 may include implementing, by each of a plurality of applications within the data integration framework, an API. The data integration framework may include a plurality of stations. Each station may correspond to one or more computing devices operating within the data integration framework. Each of the plurality of applications may correspond to a station of the plurality of stations. The plurality of stations may correspond to the plurality of stations 106. The plurality of computing devices may correspond to the computing devices 104. The plurality of applications may correspond to the applications 108.

At step 704, the data integration framework may be queried by a station health service for the plurality of applications that has implemented the API. At step 706, one or more application-specific metrics of each of the plurality of applications may be detected based on the querying. The one or more application-specific metrics may be indicative of performance and/or configuration of the application. The one or more application-specific metrics may be dynamically determinable by each application.

At step 708, a health parameter corresponding to each of the one or more application-specific metrics may be computed by the API based on the detected one or more application-specific metrics. The health parameter may be indicative of health level of the corresponding application. At step 710, information corresponding to the one or more application-specific metrics and the computed health parameters for each of the plurality of applications may be transmitted by the API.

Referring to FIG. 7b, at step 712, the information corresponding to the one or more application-specific metrics and the computed health parameters for each of the plurality of applications may be retrieved by the processing unit. At step 714, the retrieved information corresponding to each of the plurality of applications may be aggregated by the processing unit. At step 716, the retrieved information may be processed by the processing unit to assess health each of the plurality of stations. At step 718, a health dashboard may be generated by the processing unit. The health dashboard may be a GUI. At step 720, the method 700 may include displaying, by the processing unit, the assessed health of each of the plurality of stations and at least one interactive element corresponding to the one or more application-specific metrics to manage and optimize performance using the health dashboard.

In an example, the method 700 may include transmitting, by the API, a configuration link associated with each of the one or more application-specific metrics of each of the plurality of applications. The configuration link may facilitate modification of settings corresponding to the application-specific metric of the application. The assessed health of each of the plurality of stations may be displayed by the processing unit. The configuration links may correspond to each of the one or more application-specific metrics of each of the plurality of the applications using the health dashboard.

In an example, the method 700 may include computation, by the API, a health parameter corresponding to each of the one or more application-specific metrics based on a comparison with a threshold corresponding to each of the one or more application-specific metrics. In an example, the method 700 may include receiving, by the processing unit, inputs corresponding to selection of the at least one interactive element for each of the plurality of applications using the health dashboard. Access to detailed health information corresponding to each of the plurality of applications may be provided by the processing unit in response to the selection of the at least one interactive element using the health dashboard. The method 700 may include displaying, by the processing unit, the assessed health corresponding to each of the one or more application-specific metrics as a numeric score and/or a colour-coding using the health dashboard.

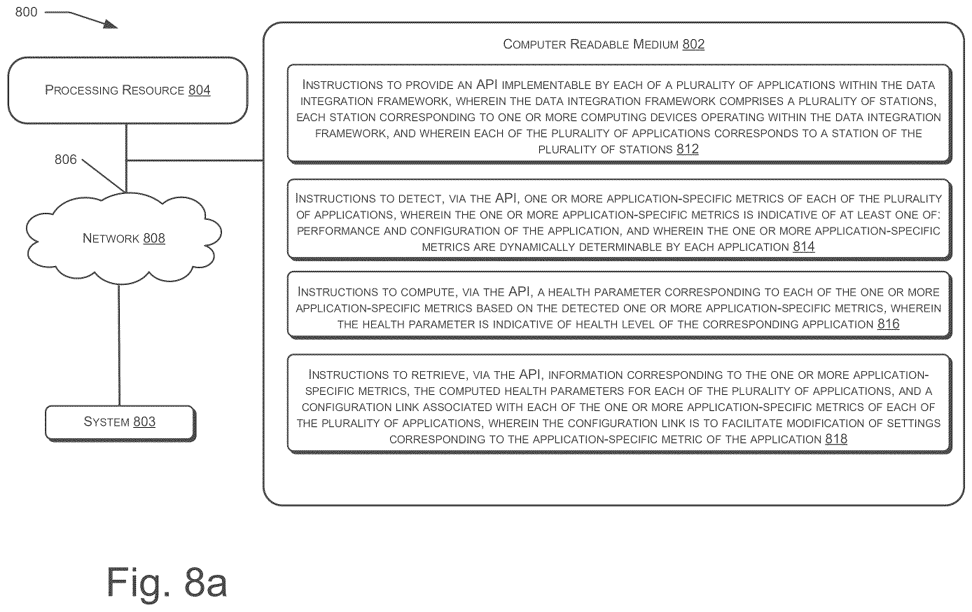

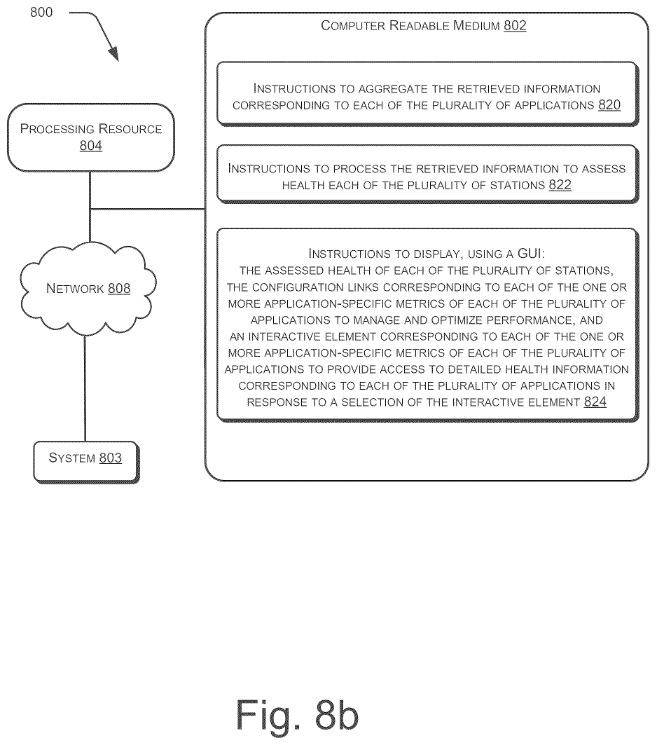

FIGS. 8a-8b illustrate a computing environment 800, implementing a non-transitory computer-readable medium for monitoring station health in a data integration framework, according to an example implementation of the present subject matter. In an example, the non-transitory computer-readable medium 802 may be utilized by the system 803. The system 803 may correspond to the system 100 or the system 300. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The non-transitory computer-readable medium 802 may be, for example, an internal memory device of the system 803 or an external memory device. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions to monitor station health data in the data integration framework. The set of computer-readable instructions can be accessed by the processing resource 804 through the communication link 806 and subsequently executed to perform acts to monitor station health data in the data integration framework. The data integration framework may correspond to the data integration framework 102.

Referring to FIG. 8a, in an example, the non-transitory computer-readable medium 802 includes instructions 812 to provide an API implementable by each of a plurality of applications within the data integration framework. The data integration framework may include a plurality of stations. Each station may correspond to one or more computing devices operating within the data integration framework. Each of the plurality of applications may correspond to a station of the plurality of stations. The plurality of applications may correspond to the applications 108. The plurality of stations may correspond to the stations 106. The plurality of computing devices may correspond to the computing devices 104.

The non-transitory computer-readable medium 802 includes instructions 814 to detect, via the API, one or more application-specific metrics of each of the plurality of applications. The one or more application-specific metrics may be indicative of performance and/or configuration of the application. The one or more application-specific metrics may be dynamically determinable by each application.

The non-transitory computer-readable medium 802 includes instructions 816 to compute, via the API, a health parameter corresponding to each of the one or more application-specific metrics based on the detected one or more application-specific metrics. The health parameter may be indicative of health level of the corresponding application.

The non-transitory computer-readable medium 802 includes instructions 818 to retrieve, via the API, information corresponding to the one or more application-specific metrics, the computed health parameters for each of the plurality of applications, and a configuration link associated with each of the one or more application-specific metrics of each of the plurality of applications. The configuration link may facilitate modification of settings corresponding to the application-specific metric of the application.

Referring to FIG. 8b, the non-transitory computer-readable medium 802 includes instructions 820 to aggregate the retrieved information corresponding to each of the plurality of applications. The non-transitory computer-readable medium 802 includes instructions 822 to process the retrieved information to assess health each of the plurality of stations. The non-transitory computer-readable medium 802 includes instructions 824 display, using a GUI the assessed health of each of the plurality of stations, the configuration links corresponding to each of the one or more application-specific metrics of each of the plurality of applications to manage and optimize performance, and an interactive element corresponding to each of the one or more application-specific metrics of each of the plurality of applications to provide access to detailed health information corresponding to each of the plurality of applications in response to a selection of the interactive element. The display may be done using a display device of the system 803. The display device may correspond to the display device of the system 100 or the system 300.

In an example, the non-transitory computer-readable medium 802 includes instructions to query, by a station health service, the data integration framework for the plurality of applications that has implemented the API and detect, via the API, the one or more application-specific metrics of each of the plurality of applications based on the querying.

The non-transitory computer-readable medium 802 includes instructions 820 to receive, via the API, a threshold corresponding to each of the one or more application-specific metrics. The non-transitory computer-readable medium 802 includes instructions 820 to compare, via the API, each of the one or more application-specific metrics and the corresponding threshold. The non-transitory computer-readable medium 802 includes instructions 820 to compute, via the API, the health parameter corresponding to each of the one or more application-specific metrics based on the comparison.

The non-transitory computer-readable medium 802 includes instructions 820 to allow, via the API, each of the plurality of applications to define the one or more application-specific metrics and a description corresponding to each of the one or more application-specific metrics. Further, the non-transitory computer-readable medium 802 includes instructions 820 to detect, via the API, the one or more application-specific metrics corresponding to each of the plurality of applications based on the defining of the one or more application-specific metrics by each of the plurality of applications.

The present subject matter allows the applications to report their own application-specific metrics and optimal configurations and/or performance parameters. Therefore, the present subject matter enables provision of deeper, meaningful, and application-specific insights into application performance instead of generic system-wide metrics. The present subject matter helps system integrators to identify and resolve configuration issues before delivering to end customers, and therefore, improving overall product quality of the data integration framework. The present subject matter allows monitoring of health of newly installed applications without requiring any update. Therefore, the present subject matter is easily scalable. By providing configuration links along with metrics, the present subject matter enables users to quickly address issues and optimize performance. The representation of the health by way of numeric score, colour coding or categorical assessment allows for easy interpretation of health across different applications. With the present subject matter, health of station in a data integration framework can be monitored efficiently. Unlike the conventional approaches, the present subject matter provides application-specific monitoring. Therefore, the present subject matter provides appropriate insights into the performance and/or configuration of each application.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for monitoring station health in a data integration framework, the system comprising:
a processing unit to:
provide an Application Programming interface (API) implementable by each of a plurality of applications within the data integration framework, wherein the data integration framework comprises a plurality of stations, each station corresponding to one or more computing devices operating within the data integration framework, and wherein each of the plurality of applications corresponds to a station of the plurality of stations;
detect, via the API, one or more application-specific metrics of each of the plurality of applications, wherein the one or more application-specific metrics is indicative of at least one of:
performance and configuration of the application, and wherein the one or more application-specific metrics are dynamically determinable by each application;
compute, via the API, a health parameter corresponding to each of the one or more application-specific metrics based on the detected one or more application-specific metrics, wherein the health parameter is indicative of health level of the corresponding application;
retrieve, via the API, information corresponding to the one or more application-specific metrics and the computed health parameters for each of the plurality of applications;
aggregate the retrieved information corresponding to each of the plurality of applications;
process the retrieved information to assess health each of the plurality of stations; and
display, using a Graphical User Interface (GUI), the assessed health of each of the plurality of stations and at least one interactive element corresponding to the one or more application-specific metrics to manage and optimize performance.

2. The system of claim 1, wherein the at least one interactive element comprises a configuration link associated with each of the one or more application-specific metrics of each of the plurality of applications, and wherein the processing unit is to:
receive, via the API, the configuration link, wherein the configuration link is to facilitate modification of settings corresponding to the application-specific metric of the application; and
display, using the GUI, the assessed health of each of the plurality of stations, and the received configuration links corresponding to each of the one or more application-specific metrics of each of the plurality of the applications.

3. The system of claim 1, wherein the processing unit is to compute, via the API, the health parameter corresponding to each of the one or more application-specific metrics based on a comparison with a threshold corresponding to each of the one or more application-specific metrics.

4. The system of claim 1, wherein the data integration framework is a Niagara platform.

5. The system of claim 1, wherein the processing unit is to display the assessed health of each of the plurality of stations via a categorical assessment, wherein the categorical assessment is indicative of at least one of performance and configuration of each of the plurality of applications as one of: optimal and non-optimal.

6. The system of claim 1, wherein the processing unit is to:
receive inputs corresponding to selection of the at least one element for each of the plurality of applications; and
provide, using the GUI, access to detailed health information corresponding to each of the plurality of applications in response to the selection of the at least one element.

7. The system of claim 1, wherein the processing unit is to display, using the GUI, the assessed health of each of the one or more application-specific metrics as at least one of: a numeric score and a colour-coding.

8. The system of claim 1, wherein the processing unit is to:
detect installation of a new application to the data integration framework;
provide the API to the new application, wherein the provision of the API allows plugging of the application for monitoring station health; and
detect, via the API, one or more application-specific metrics of the new application, wherein the one or more application-specific metrics of the new application is indicative of at least one of: performance and configuration of the new application.

9. The system of claim 1, wherein the processing unit is to:
allow, via the API, each of the plurality of applications to define the one or more application-specific metrics and a description corresponding to each of the one or more application-specific metrics; and
detect, via the API, the one or more application-specific metrics corresponding to each of the plurality of applications based on the defining of the one or more application-specific metrics by each of the plurality of applications.

10. The system of claim 1, wherein the processing unit is to:
query, using a station health service, the data integration framework for the plurality of applications that has implemented the API; and
detect, via the API, the one or more application-specific metrics of each of the plurality of applications based on the querying.

11. A method for monitoring station health in a data integration framework, the method comprising:
implementing, by each of a plurality of applications within the data integration framework, an API, wherein the data integration framework comprises a plurality of stations, each station corresponding to one or more computing devices operating within the data integration framework, and wherein each of the plurality of applications corresponds to a station of the plurality of stations;
querying, by a station health service, the data integration framework for the plurality of applications that has implemented the API;
detecting, by the API, one or more application-specific metrics of each of the plurality of applications based on the querying, wherein the one or more application-specific metrics is indicative of at least one of:
performance and configuration of the application, and wherein the one or more application-specific metrics are dynamically determinable by each application;
computing, by the API, a health parameter corresponding to each of the one or more application-specific metrics based on the detected one or more application-specific metrics, wherein the health parameter is indicative of health level of the corresponding application;
transmitting, by the API, information corresponding to the one or more application-specific metrics and the computed health parameters for each of the plurality of applications;
retrieving, by a processing unit, the information corresponding to the one or more application-specific metrics and the computed health parameters for each of the plurality of applications aggregating by the processing unit, the retrieved information corresponding to each of the plurality of applications;
processing, by the processing unit, the retrieved information to assess health each of the plurality of stations;
generating, by the processing unit, a health dashboard; and
displaying, by the processing unit, the assessed health of each of the plurality of stations and at least one interactive element corresponding to the one or more application-specific metrics to manage and optimize performance using the health dashboard.

12. The method of claim 11, comprising:
transmitting, by the API, a configuration link associated with each of the one or more application-specific metrics of each of the plurality of applications, wherein the configuration link is to facilitate modification of settings corresponding to the application-specific metric of the application; and
displaying, by the processing unit, the assessed health of each of the plurality of stations, and the configuration links corresponding to each of the one or more application-specific metrics of each of the plurality of the applications using the health dashboard.

13. The method of claim 11, comprising computing, by the API, the health parameter corresponding to each of the one or more application-specific metrics based on a comparison with a threshold corresponding to each of the one or more application-specific metrics.

14. The method of claim 11, wherein the data integration framework is a Niagara platform.

15. The method of claim 11, comprising:
receiving, by the processing unit, inputs corresponding to selection of the at least one interactive element for each of the plurality of applications using the health dashboard; and
providing, by the processing unit, access to detailed health information corresponding to each of the plurality of applications in response to the selection of the at least one interactive element using the health dashboard.

16. The method of claim 11, comprising displaying, by the processing unit, the assessed health corresponding to each of the one or more application-specific metrics as at least one of: a numeric score and a colour-coding using the health dashboard.

17. A non-transitory computer-readable medium comprising instructions for monitoring station health in a data integration framework, the instructions being executable by a processing resource to:
provide an API implementable by each of a plurality of applications within the data integration framework, wherein the data integration framework comprises a plurality of stations, each station corresponding to one or more computing devices operating within the data integration framework, and wherein each of the plurality of applications corresponds to a station of the plurality of stations;
detect, via the API, one or more application-specific metrics of each of the plurality of applications, wherein the one or more application-specific metrics is indicative of at least one of: performance and configuration of the application, and wherein the one or more application-specific metrics are dynamically determinable by each application;
compute, via the API, a health parameter corresponding to each of the one or more application-specific metrics based on the detected one or more application-specific metrics, wherein the health parameter is indicative of health level of the corresponding application;
retrieve, via the API, information corresponding to the one or more application-specific metrics, the computed health parameters for each of the plurality of applications, and a configuration link associated with each of the one or more application-specific metrics of each of the plurality of applications, wherein the configuration link is to facilitate modification of settings corresponding to the application-specific metric of the application;
aggregate the retrieved information corresponding to each of the plurality of applications;
process the retrieved information to assess health each of the plurality of stations; and
display, using a GUI:
the assessed health of each of the plurality of stations,
the configuration links corresponding to each of the one or more application-specific metrics of each of the plurality of applications to manage and optimize performance, and
an interactive element corresponding to each of the one or more application-specific metrics of each of the plurality of applications to provide access to detailed health information corresponding to each of the plurality of applications in response to a selection of the interactive element.

18. The non-transitory computer-readable medium of claim 17, the instructions being executable by the processing resource to:
query, by a station health service, the data integration framework for the plurality of applications that has implemented the API; and
detect, via the API, the one or more application-specific metrics of each of the plurality of applications based on the querying.

19. The non-transitory computer-readable medium of claim 17, the instructions being executable by the processing resource to:
receive, via the API, a threshold corresponding to each of the one or more application-specific metrics;
compare, via the API, each of the one or more application-specific metrics and the corresponding threshold; and
compute, via the API, the health parameter corresponding to each of the one or more application-specific metrics based on the comparison.

20. The non-transitory computer-readable medium of claim 17, the instructions being executable by the processing resource to:
allow, via the API, each of the plurality of applications to define the one or more application-specific metrics and a description corresponding to each of the one or more application-specific metrics; and
detect, via the API, the one or more application-specific metrics corresponding to each of the plurality of applications based on the defining of the one or more application-specific metrics by each of the plurality of applications.
